(19) United States
(12) Patent Application Publication
(10) Pub. No.: US 2007/0282494 A1
(43) Pub. Date: Dec. 6, 2007

(54) Controlling Communications Linking Among Locomotives Having Duplicate Road Numbers

(76) Inventors: Robert L. Moffitt, Palm Bay, FL (US); Brian Staton, Palm Bay, FL (US); Robert Palanti, W. Melbourne, FL (US); Steve Kellner, Melbourne, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/422,458

(22) Filed: Jun. 6, 2006

(51) Int. Cl. G05D 1/00

(52) U.S. Cl. 701/19

(57) ABSTRACT

A method for controlling communications linking among locomotives includes determining, during a communications linking procedure between a first locomotive (e.g., 12, 36) and at least one of a second locomotive (e.g., 14, 32) and a third locomotive (e.g., 16, 38), that the second locomotive and the third locomotive have duplicate locomotive identifiers. The method further includes controlling an operation of the first locomotive responsive to a determination that the second locomotive and the third locomotive have duplicate locomotive identifiers.

### FIELD OF THE INVENTION

This invention relates to the field of control of locomotives, and in particular, to controlling communications linking among locomotives having duplicate road numbers.

### BACKGROUND OF THE INVENTION

Distributed power train operation supplies motive power from a lead locomotive and one or more remote locomotives that may be spaced apart from the lead locomotive in a train consist. Each locomotive of the train may be equipped with a communication system for providing intra-train communications. Braking and traction commands may be issued to the remote locomotives via a communication link responsive to an operator using the controls at the lead locomotive. The communication link may include a wireless link between the lead locomotive and the remote locomotives maintained by the communication system.

A communications linking procedure for setting up train communications between a lead locomotive and one or more remote locomotives for distributed power operation typically includes entering a road number of the lead locomotive at the remote locomotive and then entering the remote locomotive road number at the lead locomotive. The lead locomotive then transmits a link command that includes its road number and the road number of the intended remote locomotive. The link command may also include a lead locomotive unique identifier, such as a processor address code unique to a locomotive control unit on board the lead locomotive.

Locomotives tuned to receive the lead locomotive's transmissions over the wireless link may receive the link command, but may ignore the command if the remote locomotive road number of the link command does not correspond to its road number. If the remote locomotive road number in the command matches the road number of a remote locomotive receiving the command, the remote locomotive then reads the lead locomotive road number included in the command to determine if the command is coming from its assigned lead locomotive whose road number had been previously entered at the remote locomotive. After the linking process is complete, the remote locomotive will usually only listen to lead locomotive commands including with the appropriate road number and/or unique identifier, unless it receives another lead locomotive generated link command signal.

Typically, distributed power trains are set up using locomotives from a single railroad. Accordingly, conventional distributed power train operations assume that that no duplicate road numbers exist among locomotives because the locomotives of a railroad are usually assigned unique road numbers. Furthermore, interoperability of distributed power systems among different railroads may be limited, so that duplicate road numbers of locomotives among different railroads is usually not a concern because the locomotives of different railroad may not be interoperable for distributed power operations.

In an embodiment, the invention includes a method for controlling communications linking among locomotives. The method includes determining, during a communications linking procedure between a first locomotive and at least one of a second locomotive and a third locomotive, that the second locomotive and the third locomotive have duplicate locomotive identifiers. The method also includes controlling an operation of the first locomotive responsive to a determination that the second locomotive and the third locomotive have duplicate locomotive identifiers.

In another aspect of the invention, controlling communications linking among locomotives includes issuing a link request from a lead locomotive to a first remote locomotive desired to be controlled by the lead locomotive and receiving at the lead locomotive a first reply from the first remote locomotive responsive to the link request and a second reply from a second remote locomotive responsive to the link request, the first remote locomotive and second remote locomotive being identified in their replies by the respective predetermined identifiers. The method also includes determining that the first remote locomotive and the second remote locomotive are identified by the same predetermined identifier and limiting further communications between the lead locomotive and the first remote locomotive and second remote locomotive.

In another aspect of controlling communications linking among locomotives, the invention includes establishing a communications link between a first lead locomotive and a remote locomotive desired to be controlled by the first lead locomotive and subsequently receiving at the remote locomotive a communications link request from a second lead locomotive, the link request being encoded with a primary identifier of the second lead locomotive the same as a primary identifier of the first lead locomotive and a secondary identifier of the second lead locomotive different than a secondary identifier of the first lead locomotive. The method also includes determining at the remote locomotive that the secondary identifier of the second lead locomotive encoded in the communications link request is different than the secondary identifier of the first lead locomotive and ignoring the communications link request from the second lead locomotive.

In another embodiment of the invention, a system for controlling communications linking among locomotives includes a receiver onboard a first locomotive for receiving communication linking signals from a second locomotive and a third locomotive. The system also includes a processor coupled to the receiver for determining, during a communications linking procedure between the first locomotive and at least one of the second and third locomotives, that the second and third locomotives have duplicate locomotive identifiers and for controlling an operation of the first locomotive responsive to the second and third locomotives having duplicate locomotive identifiers.

In yet another embodiment, the invention includes computer readable media containing program instructions for controlling communications linking among locomotives. The computer readable media includes a computer program code for determining, during a communications linking procedure between a first locomotive and at least one of a second locomotive and a third locomotive, that the second locomotive and the third locomotive have duplicate locomotive identifiers. The computer readable media also includes a computer program code for controlling an operation of the first locomotive responsive to a determination that the second locomotive and the third locomotive have duplicate locomotive identifiers.

### BRIEF DESCRIPTION OF THE DRAWINGS

FIG. 1 is a schematic diagram of an exemplary system for controlling communication linking between a lead locomotive and remote locomotives having duplicate road numbers.

FIG. 2 is a schematic diagram of an exemplary system for controlling communication linking between a remote locomotive and lead locomotives having duplicate road numbers.

### DETAILED DESCRIPTION OF THE INVENTION

Recently, some railroads have begun using locomotives from different railroads that have compatible distributed power operating systems but may also have duplicate road numbers. Consequently, it may be possible to have locomotives with duplicate road numbers capable of communicating with each other within a railway fleet. In most cases duplicate road numbered locomotives will not cause problems with distributed power operations due to the built in safeguards. For example, the distributed power system may prevent linking when a duplicate road number is attempted to be entered at either a remote locomotive or a lead locomotive. However, the present inventors have identified certain cases when duplicate road numbers may cause problems during a communications linking procedure. For example, when a lead locomotive attempts to link with a first remote locomotive having the same road number as a second remote locomotive of a train, both remote locomotives may link, but only the first linked remote locomotive will be recognized by the lead locomotive.

In another problematic situation recognized by the inventors, when first and second trains operating within each other's range of communication include respective lead locomotives having the same road numbers, and the first train includes a remote locomotive having the same road number as a remote locomotive of the second train, communication linking may be compromised. If both trains are set up to link, and the first train links first, the lead locomotive of the first train will link to the remote locomotives in both trains because they have the same road number and are both configured to link to the same lead road number. The lead locomotive of the first train may then have control over both remote locomotives of the first train and the second train and may inadvertently operate the remote locomotive in the second train contrary to commands from the lead locomotive of the second train. Furthermore, if the lead locomotive of the second train attempts to link to its remote locomotive, the remote locomotives of both trains may unlink from the lead locomotive of the first train and relink to the lead locomotive of the second train, which may result in a communications lose indication provided to an operator of lead locomotive of the first train. To remedy such situations, the inventors have developed an innovative technique for controlling communications linking among locomotives so that duplicate road number conflicts among the locomotives are limited.

In an exemplary embodiment, a method of controlling communications linking among locomotives may include identifying, during a communications linking procedure among locomotives, at least two of the locomotives having duplicate locomotive identifiers. The method may also include controlling an operation of at least one of the locomotives responsive to the identification of locomotives having duplicate locomotive identifiers.

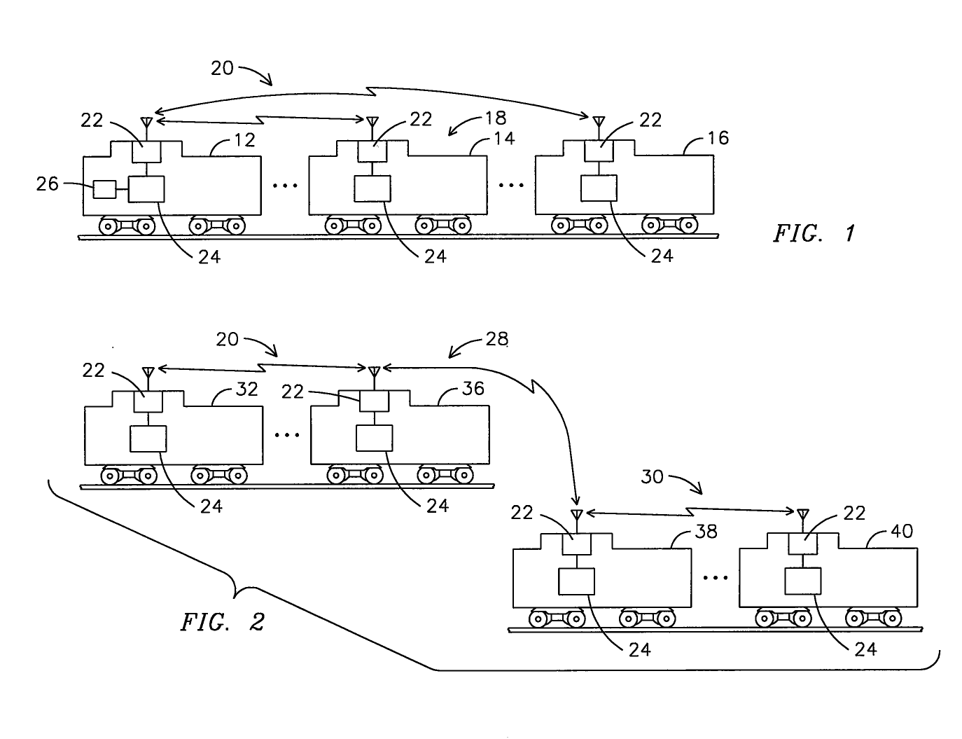

FIG. 1 illustrates an exemplary embodiment of the invention directed to a lead locomotive 12 and remote locomotives 14, 16 of a train 18 in which the remote locomotives 14,16 have duplicate identifiers, such as the same road number. Each locomotive 12,14,16 may include a transceiver 22 for transmitting and receiving information over the communications link 20 and a processor 24 for processing received signals and generating information to be transmitted via the transceiver 22 over the communication link 20. A method for controlling communications linking among the locomotives 12, 14, 16 may include issuing a communications link request over communications link 20 from the lead locomotive 12 to the first remote locomotive 14 desired to be controlled by the lead locomotive 12. The method may further include receiving at the lead locomotive 12 a first reply from the first remote locomotive 14 and a second reply from a second remote locomotive 16 over the communication link 20 responsive to the link request. Upon receiving the two replies from the remote locomotives 14,16, the lead locomotive 12 may limit further communications between the lead locomotive 12 and the first remote locomotive 14 and/or the second remote locomotive 16 For example, the lead locomotive 12 may unlink from either or both remote locomotives 14, 16. In another aspect, the method may include providing an indication to an operator of the lead locomotive 12 via display 26 to alert the operator that two remote locomotives having the same road number have been identified. The operator may then be prompted to take further action, such as switching out one the remote locomotives 14, 16.

In an aspect of the invention, one or more processors 24 may be configured for performing the above described method. The steps necessary for accomplishing the method may be embodied in hardware, software and/or firmware in any form that is accessible and executable by processor 24 and may be stored on any medium that is convenient for the particular application. Processor 24 may take any form known in the art, for example an analog or digital microprocessor or computer, and it may be integrated into or combined with one or more controllers used for other functions related to the locomotive operations.

FIG. 2 illustrates another exemplary embodiment of the invention directed to first train 28 and second train 30 including train lead locomotives 32, 38 having the same lead locomotive road numbers. The trains 28, 30 also include train remote locomotives 36, 40 having the same remote locomotive road numbers. Each locomotive 32,36,38,40 may include a transceiver 22 for transmitting and receiving information over the communications link 20 and a processor 24 for processing received signals and generating information to be transmitted via the transceiver 22 over the communication link 20. When such trains 28, 30 are operated sufficiently close such that a communication link 20 may be established between both trains 28, 30, communication linking problems may arise as a result of the duplicate lead road numbers and duplicate remote road numbers.

Accordingly, another exemplary communications linking control method may include ensuring, after being linked, that a remote locomotive responds only to its assigned lead locomotive responsive to a re-linking command. The method may include establishing a communications link between the first train lead locomotive 32 and the first train remote locomotive 36 desired to be controlled by the first train lead locomotive 32. The method may then include receiving, at the first train remote locomotive 36, a communications link request from a second train lead locomotive 38 within communications range. The link request may be encoded with a primary identifier of the second train lead locomotive 38, such as a road number that is the same as a primary identifier of the first train lead locomotive 32. The link request may also be encoded with and a secondary identifier of the second train lead locomotive 38, such as a unique processor address code, different than a secondary identifier of the first train lead locomotive 32.

The link request may be intended for the second train remote locomotive 40 assigned to the second train lead locomotive 38, but may be recognized by the first train remote locomotive 36 due to the primary identifier encoded in the request being the same as the first train lead locomotive's primary identifier to which the first train remote 36 is already linked. The method may then include determining, at the first train remote locomotive 36, that the secondary identifier of the second train lead locomotive encoded in the communications link request is different than the secondary identifier of the first train lead locomotive 32 to which it is currently linked. The first train remote locomotive 36 may then ignore the communications link request from the second train lead locomotive 38 because the linking request has been issued from a locomotive different from the second train remote locomotive's assigned lead locomotive 32.

Based on the foregoing specification, the invention may be implemented using computer programming or engineering techniques including computer software, firmware, hardware or any combination or subset thereof, wherein the technical effect is to control communications linking among locomotives having duplicate road numbers. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A method for controlling communications linking among locomotives comprising:
determining, during a communications linking procedure between a first locomotive and at least one of a second locomotive and a third locomotive, that the second locomotive and the third locomotive have duplicate locomotive identifiers; and
controlling an operation of the first locomotive responsive to a determination that the second locomotive and the third locomotive have duplicate locomotive identifiers.

2. The method of claim 1, wherein the first locomotive comprises a lead locomotive of a train and the second locomotive and the third locomotive comprise remote locomotives of the train, the method further comprising issuing a communications link request from the first locomotive to the second locomotive desired to be controlled by the first locomotive.

3. The method of claim 2, further comprising identifying receipt at the first locomotive of a first reply from the second locomotive responsive to the communication link request and of a second reply from the third locomotive responsive to the communication link request.

4. The method of claim 3, further comprising limiting further communications between the first locomotive and the second locomotive and the third locomotive responsive to receipt of the first and second replies.

5. The method of claim 3, further comprising alerting an operator of the first locomotive that the second locomotive and third locomotive have duplicate identifiers.

6. The method of claim 1, wherein the second locomotive comprises a lead locomotive of a first train and the first locomotive comprises a remote locomotive of the first train, the method further comprising establishing a communications link between the first locomotive and the second locomotive.

7. The method of claim 6, wherein the third locomotive comprises a lead locomotive of a second train attempting to link to a remote locomotive of the second train having a primary identifier identical to a primary identifier of the first locomotive by issuing a communications linking request encoded with a primary identifier of the third locomotive the same as a primary identifier of the second locomotive and a secondary identifier of the third locomotive different than a secondary identifier of the second locomotive, the method further comprising the first locomotive determining that the secondary identifier of the third locomotive encoded in the communications link request is different than the secondary identifier of the second locomotive.

8. The method of claim 7, wherein the primary identifiers comprise respective road numbers of the second and third locomotives.

9. The method of claim 7, wherein the secondary identifiers comprises respective unique codes assigned to locomotive control units on-board the second and third locomotives.

10. The method of claim 7, further comprising determining that the secondary identifier of the third locomotive encoded in the communications link request is different than the secondary identifier of the second locomotive.

11. The method of claim 10, further comprising the first locomotive ignoring the communications link request from the third locomotive.

12. A method for controlling communications linking among locomotives comprising:
issuing a link request from a lead locomotive to a first remote locomotive desired to be controlled by the lead locomotive;
receiving at the lead locomotive a first reply from the first remote locomotive responsive to the link request and a second reply from a second remote locomotive responsive to the link request, the first remote locomotive and second remote locomotive being identified in their replies by the respective predetermined identifiers;
determining that the first remote locomotive and the second remote locomotive are identified by the same predetermined identifier; and
limiting further communications between the lead locomotive and the first remote locomotive and second remote locomotive.

13. A method for controlling communications linking among locomotives comprising:
establishing a communications link between a first lead locomotive and a remote locomotive desired to be controlled by the first lead locomotive;
receiving at the remote locomotive a communications link request from a second lead locomotive, the link request being encoded with a primary identifier of the second lead locomotive the same as a primary identifier of the first lead locomotive and a secondary identifier of the second lead locomotive different than a secondary identifier of the first lead locomotive;
determining at the remote locomotive that the secondary identifier of the second lead locomotive encoded in the communications link request is different than the secondary identifier of the first lead locomotive; and
ignoring the communications link request from the second lead locomotive.

14. A system for controlling communications linking among locomotives comprising:
a receiver onboard a first locomotive for receiving communication linking signals from a second locomotive and a third locomotive; and
a processor coupled to the receiver for determining, during a communications linking procedure between the first locomotive and at least one of the second and third locomotives, that the second and third locomotives have duplicate locomotive identifiers and for controlling an operation of the first locomotive responsive to the second and third locomotives having duplicate locomotive identifiers.

15. The system of claim 14, wherein the first locomotive comprises a lead locomotive of a train and the second locomotive and the third locomotive comprise remote locomotives of the train, the processor further configured for issuing a communications link request from the first locomotive to the second locomotive desired to be controlled by the first locomotive.

16. The system of claim 15, the processor further configured for identifying receipt at the first locomotive of a first reply from the second locomotive responsive to the communication link request and of a second reply from the third locomotive responsive to the communication link request.

17. The system of claim 16, the processor further configured for limiting further communications between the first locomotive and the second locomotive and the third locomotive responsive to receipt of the first and second replies.

18. The system of claim 14, wherein the second locomotive comprises a lead locomotive of a first train and the first locomotive comprises a remote locomotive of the first train, the processor further configured for establishing a communications link between the first locomotive and the second locomotive.

19. The system of claim 18, wherein the third locomotive comprises a lead locomotive of a second train attempting to link to a remote locomotive of the second train having a primary identifier identical to a primary identifier of the first locomotive by issuing a communications linking request encoded with a primary identifier of the third locomotive the same as a primary identifier of the second locomotive and a secondary identifier of the third locomotive different than a secondary identifier of the second locomotive, the processor further configured for determining that the secondary identifier of the third locomotive encoded in the communications link request is different than the secondary identifier of the second locomotive.

20. The system of claim 19, the processor of the first locomotive further configured for ignoring the communications link request from the third locomotive responsive to a determination that the secondary identifier of the third locomotive encoded in the communications link request is different than the secondary identifier of the second locomotive.

21. Computer readable media containing program instructions for controlling communications linking among locomotives, the computer readable media comprising:
a computer program code for determining, during a communications linking procedure between a first locomotive and at least one of a second locomotive and a third locomotive, that the second locomotive and the third locomotive have duplicate locomotive identifiers; and
a computer program code for controlling an operation of the first locomotive responsive to a determination that the second locomotive and the third locomotive have duplicate locomotive identifiers.
